(19) United States
(12) Patent Application Publication
(10) Pub. No.: US 2003/0138182 A1
(43) Pub. Date: Jul. 24, 2003

(54) Device for converting light having a polarisation pe into light having a predetermined polarisation pa

(76) Inventors: Wolfgang Dultz, Frankfurt/M (DE); Reinald Ries, Darmstadt (DE); Erna Frins, Montevideo (UY)

Correspondence Address: KENYON & KENYON, ONE BROADWAY, NEW YORK, NY, 10004, US

(21) Appl. No.: 10/239,951

(22) PCT Filed: Feb. 24, 2001
(86) PCT No.: PCT/EP01/02109

(30) Foreign Application Priority Data
Mar. 24, 2000 (DE) 10014830.1

(51) Int. Cl. G02B 6/00

(52) U.S. Cl. 385/11

(57) ABSTRACT

To simplify the adaptation of a polarization that fluctuates over time to a predefined polarization state, a device for converting the polarization of light is proposed, which can be manufactured cost-effectively and operated with minimal outlay. For this, the device has an input (E) for receiving light having any polarization P_{E} at all, as well as an output (A) for emitting light having a predefined polarization P_{A}. A device (PBS) splits the received light into variably polarized light components, one of the light components propagating through a device (P₁, P₂) for adjusting the polarization. The light components are again coupled in a device (C), the coupling being adjustable for outputting light with a maximum output intensity, and this light being able to be output with the predefined polarization P_{A} at the output (A). In this manner, it is only necessary to control one single physical parameter in the form of the coupling of the light components to optimize the device according to the present invention.

The present invention is directed to a device for converting light having any polarization at all into light having a predefined polarization, and to a method for operating the same.

Today, virtually exclusively photonic networks are used to transmit communications over large distances. Most of the optical components used for this purpose have a transmission characteristic which is dependent upon the polarization or which changes the polarization of the light. The influences can be of a static or dynamic nature, depending on whether the effects have a time dependency or not.

For example, when light is transmitted through a laid optical fiber, it undergoes a polarization variation having time constants ranging from hundredths of seconds to hours. For this reason, the optical components used in telecommunications must often have a polarization-neutral design, or such a polarization neutrality must be achieved by splitting the light path for the two orthogonal polarization states. However, this doubles the optical components and, accordingly, is cost intensive. When a passive component, in particular a linearly polarizing analyzer, is used, a predefined polarization state is, in fact, provided. In an unfavorable case, however, it holds the risk of complete loss of the optical power.

Another approach provides for controlling the polarization state of the light following each cable route and before polarization-dependent components, such as filters, separating filters, optical amplifiers and interferometric switches. Controlling the polarization state of the light in this manner at the end of an optical cable route is described, for example, in the German Patent Application DE 198 33 312, the device including a measuring device for the polarization state of the light, an electronic control unit, and a polarization controller. The drawback, however, of the described and of all other known active polarization modulators is that at least two physical parameters need to be changed in order to convert a generally elliptical polarization state into a predefined linear polarization state in an essentially lossless manner.

The object of the present invention is, therefore, to provide a device for converting the polarization of light into a predefined polarization, which, on the one hand, can be manufactured simply and cost-effectively and, on the other hand, simplifies the process of adapting a polarization that fluctuates over time to a predefined polarization state.

The present invention achieves this technical objective by providing a device having the features of Claim 1 and, respectively, a method for operating such a device according to Claim 11.

To simply convert the polarization state of light into a predefined polarization state, for example for coupling into a specific optical component, the device for converting polarization includes an input for receiving light having a polarization P_{E} which typically varies over time. At the output, the device supplies light having a predefined polarization P_{A}. Also provided is a device for splitting the received light into variably polarized light components, as well as a device for adjusting the polarization in at least one of the light components. In one coupling device, the light components are reunited, the coupling being adjustable for outputting light with a maximum output intensity, and this light being able to be output with a predefined polarization P_{A} at the output of the device according to the present invention.

Advantageous further refinements are delineated in the dependent claims.

To split the received light, the device according to the present invention may have a polarizing beam splitter, which splits the light incident thereto into two mutually perpendicular, linearly polarized components.

Depending on the specific embodiment, the device for adjusting the polarization in at least one portion of the received light may include a polarization controller in accordance with the related art. It is particularly advantageous when the polarization controller is designed as a Berry-phase rotator, which is able to rotate the polarization of a linearly polarized light beam by 90 degrees. In comparison to a λ/2 plate, the Berry phase rotator has the advantage of working independently of wavelength. In the case at hand, it converts the polarization of the one beam into the polarization of the second beam in a lossless manner.

To reunite the two light components, the device for coupling the light includes two inputs which each receive one of the portions of the light, i.e., one light beam. To be able to adjust the coupling in defined fashion, a phase modulator is positioned upstream from one of the two inputs. The allocated portions of the light propagate through the phase modulator prior to entering into the device for coupling light components.

To output the light and adjust the coupling, the device for coupling the light has two outputs. Connected in series to the first output is a light-sensitive detector which emits at least one signal for determining at least one control signal for the phase modulator, and, at the second output, the light is able to be output with the predefined polarization P_{E}.

To determine at least one control signal for the phase modulator, the device may include a device for generating at least one control signal, this device being connected on the input side to the detector and, on the output side, to the phase modulator.

To adjust the coupling of the light components in the coupling device, the modulation of the phase is adjustable in one of the light components, given an optimized coupling, the light intensity of the light emitted at the second output being maximized with the predefined polarization P_{E} Accordingly, compared to other polarization modulators, a benefit of the device according to the present invention is that only one single physical parameter, here the phase in one of the light beams, needs to be adjusted. To provide a reciprocal action of the light components in the coupling device, this device may be a polarization-conserving interference coupler, for example a polarization-conserving beam splitter or a polarization-conserving fiber coupler. Accordingly, by introducing a phase shift into one portion of the light, the interference coupling may be controlled in the coupling device. By controlling to a minimal outcoupling of light out of the first output of the coupling device, the intensity of the light having predefined polarization P_{A} emitted at the second output of the coupling device may be maximized.

The device according to the present invention also has the advantageous property that, independently of the polarization of the light at the input of the device, at least 50% of the incoming optical power may be converted into light having the desired polarization and emitted at the output. A complete loss, as can occur, for example, when a linearly polarizing analyzer is used, is avoided. To operate a device according to the present invention using an interference-coupling device, coherent light must be available. However, in view of today's narrow-band laser sources in optical information transmission technology, particularly in telecommunications, this does not pose a problem.

A multitude of specific embodiments are possible for the device according to the present invention. This relates, for example, to a device for converting the polarization of light, which is mounted on an optical table, or to a device which is manufactured using integrated optics.

The present invention is elucidated in the following based on the description of a specific embodiment, reference being made to the drawing, whose figures show:

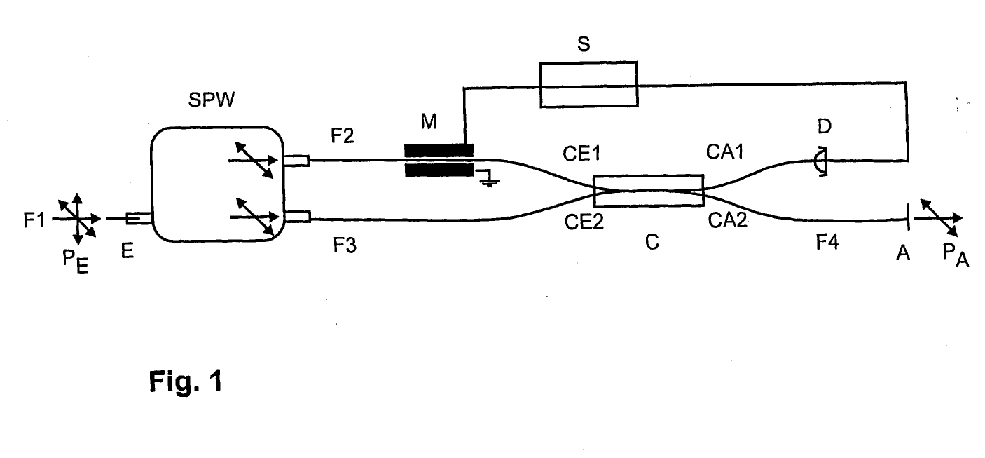

FIG. 1 the exemplary embodiment in its totality in a diagrammatic sketch; and

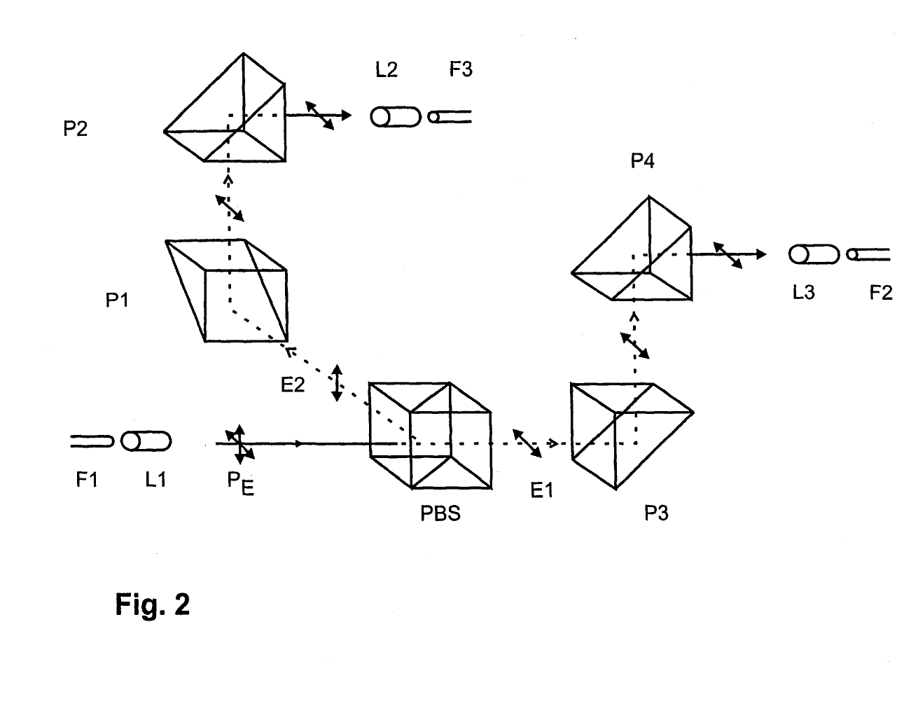

FIG. 2 specific devices of the exemplary embodiment in detail.

The specific embodiment shown in FIG. 1 of a device for converting the polarization of light into a predefined polarization is designed to be mounted behind an optical cable route. The device according to the present invention is used for canceling out time-dependent fluctuations in the polarization, in order to make the light having a defined polarization available to a processing or to a retransmission.

For this, optical fiber path F1 is coupled to input E of the device. The input is followed by a device SPW, in which the incident light is split as a function of polarization and, in one portion of the light, its polarization is altered in such a way that the light components have the same polarization at both outputs of the device. Both light components are conducted via glass fibers to a fiber coupler C. Prior to entering into the fiber coupler, one of the two light beams undergoes a phase modulation in a modulator M. Device C, designed as a polarization-conserving interference coupler, has a first output CA1 and a second output CA2, the second output being linked via a fiber F4 to output A of the device according to the present invention for emitting light having a predefined polarization PA. Connected downstream from first output CA1 of coupling device C is a light-sensitive detector D, which is linked to a control device S which drives phase modulator M.

The mode of operation can be described as follows, with reference to FIG. 2, which shows, in particular, device SPW in detail. The light having polarization P_{E} which varies over time is fed through fiber F1 to the device. After emerging from the fiber, the light propagates through a Grin lens (graded-index lens), which adapts the opening angle of the light to the optical components that follow. The light having, in principle, any polarization at all, falls on a polarizing beam splitter PBS, which splits the received light into two mutually perpendicular, linearly polarized components E1 and E2. In the process, component E1, passed through the beam splitter, is horizontally polarized, and component E2, reflected by the beam splitter, is vertically polarized. The two light components propagate through assigned prisms P3, P4 and P1, P2, respectively. Prisms P3 and P4 are primarily used only for deflecting beam component E1. For light component E2, prism P1 functions as a Berry phase rotator, which converts the vertical polarization of the light into a horizontal polarization. The method of functioning of such a Berry phase rotator is described, for example, in the essay by M. Berry, Nature, vol. 326, page 277 (1997). Prism P2 that follows rotator P1 effects a reversal of direction of the beam. To couple in the particular light components, Grin lenses L3 and L2, respectively, are used, which couple in the light components in question into assigned fibers F2 and F3, respectively, both light components having the same polarization. The two light components are each introduced at an input CE1 or CE2 into a fiber coupler C. In this context, a light beam propagates through a phase modulator M, which is designed as an electrically controllable electrooptical crystal in accordance with the related art. The phase modulator is driven by a control device S. Since fiber coupler C is designed as an interference coupler, device S may drive modulator M to influence and control the coupling in coupling device C. In dependence upon the relative phase angles of the two superposed light components in the coupling device, the light is output at one of the two outputs CA1 or CA2, or fractional amounts of the light, which are dependent upon the coupling, are output at both outputs. The light output at first output CA1 is detected by a light-sensitive detector D, which transmits an electrical signal associated with the light intensity to control device S, which, in response to this electrical signal, drives the phase modulator. In this context, the coupling of the light components in the coupling device is controlled in such a way via the phase modulator that the optical power output at first output CA1 is minimal, and, therefore, the optical power output at second output CA2 is maximal. Therefore, it is only necessary to control one single physical parameter in the form of the coupling of the light components to optimize the device according to the present invention. Coupling device C is fundamentally known and functions in a polarization-conserving manner. Accordingly, the light output at second output CA2 is horizontally linearly polarized in a defined fashion. The light emitted at the coupling device is conducted by a fiber F4 to output A of the device according to the present invention, where light of predefined polarization P_{A} is, therefore, emitted.

In dependence upon input polarization P_{E}, the optical power at output A of the device amounts to 50% to 100% of the input power having the predefined linear polarization state P_{A}. The value of 50% is derived in the case that the light is horizontally or vertically linearly polarized in the input, i.e., power is coupled in at input beam splitter PBS in only one arm of the Mach-Zehnder interferometer. 100% of the input power is coupled out at output A, when the light is coupled in the input, by one half each, into the two interferometer arms, thus, for example, light which is circularly polarized or is linearly polarized to less than 45 degrees.

The described specific embodiment of the present invention works accordingly as a tunable Mach-Zehnder interferometer, polarizing beam splitter PBS and coupling device C representing the beam-splitting components. In place of fiber coupler C, another specific embodiment of the present invention also provides for using a conventional beam splitter. In another specific embodiment of the present invention, another interferometer type may also be used.

What is claimed is:

1. A device for converting the polarization of light into a predefined polarization, comprising:
an input (E) for receiving light having a polarization P_{E};
an output (A) for emitting light having a predefined polarization P_{A};
a device (PBS) for splitting the received light into variably polarized light components;
a device (P₁, P₂) for adjusting the polarization in at least one of the light components;
a device (C) for coupling the light components, the coupling being adjustable for outputting light with a maximum output intensity, and this light being able to be output with the predefined polarization P_{A} at the output (A).

2. The device as recited in claim 1,
wherein the device for splitting the received light is a polarizing beam splitter (PBS), which splits the received light into two mutually perpendicular, linearly polarized components.

3. The device as recited in claim 1 or 2,
wherein the device for adjusting the polarization of the light has a Berry phase rotator (P₁, P₂).

4. The device as recited in claims 2 and 3,
wherein the polarization of the first light component is able to be converted into the polarization of the second light component by the device for adjusting the polarization.

5. The device as recited in one of claims 1 through 4,
wherein the coupling device (C) is a polarization-conserving interference coupler, in particular, a polarization-conserving beam splitter or a polarization-conserving fiber coupler.

6. The device as recited in one of claims 1 through 5,
wherein the device for coupling light components includes two inputs (CE1, CE2) which each receive one of the portions of the light, a phase modulator (M) being positioned upstream from one of the inputs (CE1).

7. The device as recited in claim 6,
wherein the device for coupling the light components has two outputs (CA1, CA2), connected in series to the first output (CA1) is a light-sensitive detector (D) which emits at least one signal for determining at least one control signal for the phase modulator (M), and, at the second output (CA2), the light is able to be output with the predefined polarization P_{E}.

8. The device as recited in claims 6 and 7,
characterized by a device (S) for generating at least one control signal, the device (S) being connected on the input side to the detector (D) and, on the output side, to the phase modulator (M).

9. The device as recited in claim 7 or 8,
wherein the coupling of the light components in the coupling device (C) is adjustable through the modulation of the phase in one of the light components, given an optimized coupling, the light intensity of the light emitted at the second output (CA2) being maximizable.

10. The device as recited in one of claims 1 through 9,
wherein the device includes a tunable Mach-Zehnder interferometer, in which the incident light is able to be split by a polarizing beam splitter (PBS) into two mutually perpendicular, linearly polarized light components, and, in one of the arms of the interferometer, the polarization of the light is able to be converted into the polarization of the light in the other arm, and, in one of the arms of the interferometer, a phase modulator (M) is positioned, which is able to be driven in dependence upon the light intensity at one of the outputs (CA1, CA2) of the interferometer.

11. A method for operating a device for converting the polarization of light into a predefined polarization, in particular of a device according to one of the preceding claims 1 through 10,
characterized by the steps:
splitting the light into variably polarized light components;
changing the polarization at least in one of the components of the light;
modulating the phase of at least one of the components of the light;
coupling of the light components in a coupling device (C).

12. The method as recited in claim 11,
characterized in that the intensity of the light output at an output (A) is maximized by changing the phase of at least one of the components of the light.

13. The method as recited in claim 11 or 12,
characterized in that the light intensity is measured at an output (CA1) of the coupling device (C), and, functioning in response to the measuring signal, the phase is changed in at least one of the components of the light.

14. The method as recited in claim 11, 12 or 13,
characterized in that, in the coupling device (C), light components are brought into interference, and the light intensity at one output (CA1) of the coupling device is minimized by driving the phase modulator (M) accordingly.
